(19) United States
(12) Patent Application Publication
(10) Pub. No.: US 2021/0019356 A1
(43) Pub. Date: Jan. 21, 2021

(54) SYSTEM AND METHOD OF AUTOMATICALLY MATCHING AND RANKING RECORDS TO FACILITATE USER INTERACTION AND TRANSACTIONS

(71) Applicant: Jumpt LLC, Aventura, FL (US)

(72) Inventor: Glenn Orgin, Aventura, FL (US)

(21) Appl. No.: 16/513,901

(22) Filed: Jul. 17, 2019

(51) Int. Cl. G06F 16/9535; G06F 16/2457

(52) U.S. Cl. CPC G06F 16/9535; G06F 16/24575; G06F 16/24578

(57) ABSTRACT

A system for automatically matching and ranking records facilitates user interaction and transactions. The system has a platform host that communications with user devices and an optional service bureau. The user devices create profiles on the platform host in accordance with a variety of user data points relating to demographics, wants, needs, and interests. The platform host compares and ranks a user profile with other user profiles without a search or other request from the user device. Matches are determined according to a pre-determined scoring rubric. Matches are ranked and outputted to the user device after which the user device can initiate communications or transaction requests with other user devices or profiles.

### CROSS-REFERENCE TO RELATED APPLICATIONS

N/A

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

In the drawings:

FIG. 1 is a system environment, according to an embodiment.

FIG. 2 describes a method for using the matching and ranking system, according to an embodiment.

FIG. 3 describes a method for using the matching and ranking system, according to another embodiment.

FIG. 4 is a computing environment, according to an embodiment.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

### Matching Methodology

Broadly described, the present invention comprises various embodiments of a computer-implemented method for intaking and processing a set of data points for the purpose of matching or pairing data points in a database to create one or more match records and then providing the one or more match records to a user via a user interface of a computing device without the need for the user to actively submit search queries or requests into the system. After being presented automatically with a list of relevant match records, the user can employ a plurality of user interactivity inputs such as inputting by text/keyboard, swiping, sliding, voice commands, or body gestures in order to interact with the match records and to initiate an action or reach a desired goal, such as communicating with another user or outside person or entity or engaging in a transaction with another user or outside person or entity.

In some embodiments, the system facilitates the creation of user profiles, which permits users to establish one or more profiles by inputting to the system a plurality of user data points relevant to the user's demographics, background, wants, desires, or the like. In some embodiments, the system is capable of automatically generating relevant user data points by interfacing with one or more data service bureaus or clearinghouses. Once a profile is created, the system can then either automatically or based on user command begin executing match routines in order to match a first user profile with at least one other user profile.

In some embodiments, a match is determined by the match routine based on a plurality of user data points which are compared between one profile and at least one other profile stored in the computer-implemented system. In some embodiments, the relevancy of a match is based on a simple score determined by the number of exact matches of data points divided by the number of relevant or available data points. In other embodiments, the relevancy of a match is determined based on a weighted score of the plurality of data points wherein a first data point is given greater weight than a second data point, the second data point is given greater weight than a third data point, the third data point is given greater weight than a fourth data point, and so on. The matched records generated by the match routine are ranked by a score value which designates the importance or relevancy of the match to the user. The matched records are provided to the user via the user interface and, in some embodiments, may be sorted or ranked by the score value. In some embodiments, the user interface is audiovisual in nature such as through a desktop, laptop, mobile, virtual reality (VR) headset, and a holographic headset including those enabled with audio, using a personal digital voice assistant, speakers, vibrational enabled devices, or earphones. In some embodiments, the matched records may be sorted or filtered by other categories determined either by the host or the user, or both.

The computer-implemented system and method can facilitate a wide variety of interactions between and among users and outsides parties including assisting with and streamlining decision-making processes. The system and method can be useful for determining suitability; saving time; synchronizing interests; negotiating and finalizing an agreement; making meaningful connections; building wealth; establishing relationships; discovering people, places, and assets; planning travel; buying or selling a product, asset or services; allowing for groups or individuals to discover new events, games, restaurants, or other business; making better decisions, meeting professionals or businesses in a particular industry for personal and/or financial gain; discovering individuals and entities that provide a services; identifying relevant healthcare professions; identifying information in order to determine the next best course of action; identifying and selecting the best destination between or more locations such as for travel or relocation.

### Matching System and Network-Enabled Platform Host

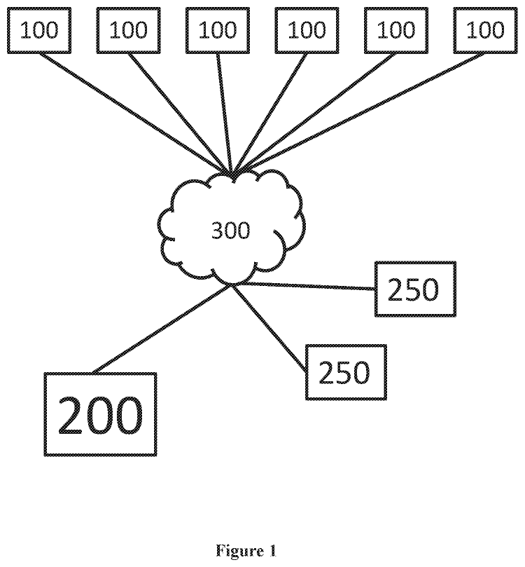

FIG. 1 illustrates one embodiment of an information system that facilitates management and execution of the methodology described herein. The system includes a one or more user devices 100 that communicate with the at least one system platform host 200. The user devices 100 and the host 200 are in communication over a communications network 300 such that the user device 100 can access the host 200 to send and receive data thereto and therefrom. In some embodiments, the host 200 is in communication with one or more data service bureaus or data clearinghouses 250, also over communications network 300. The information system, in some embodiments, comprises an internet-enabled computing system whereby the user devices 100 access an internet-based platform served by the platform host 200 which facilitates and carries out the matching routine and methodology described herein. In some embodiments, the communications network 300 comprises a wide area network. In other embodiments, the communications network comprises a local area network. In yet other embodiments, one or more of the user devices 100 is configured to locally store data received from the host 200 via the communications network 300 or otherwise, to enable “off-line” use.

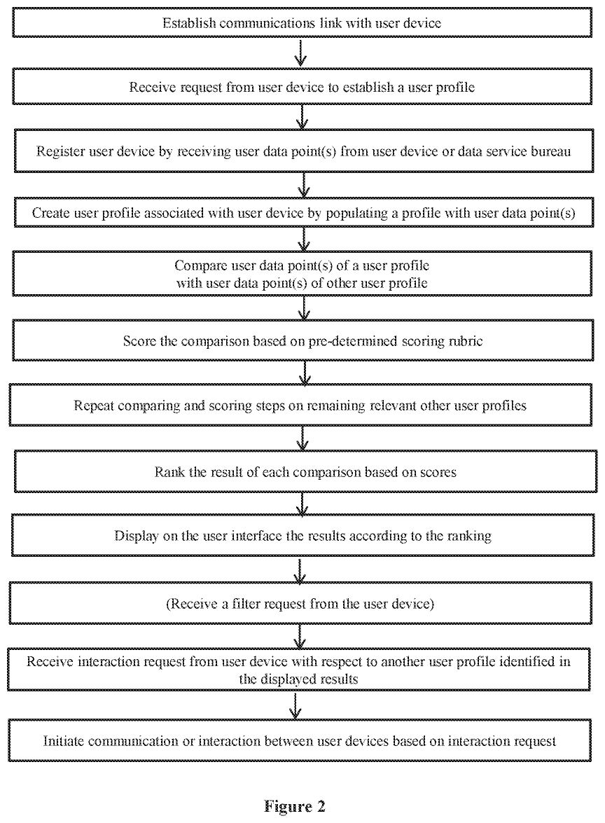

With reference to FIG. 2, shown are the method steps from the perspective of the platform host 200 according to one embodiment. A communications link is established between a plurality of user devices 100 and the platform host 200. The platform host 200 receives a request from one or more user devices 100 to establish a user profile. The platform host 200 registers the user device 100 by receiving from the user device or data service bureau 250 one or more user data points relevant to the user device 100. In some embodiments, the platform host 200 can transmit a data query to a service bureau 250 based on one or more user data points received for the user device 100 in order to obtain additional data points from the service bureau. For example, the platform host 200 can receive from the user device 100 a name, date of birth, and social security number which data set the platform host 200 can than transmit to the service bureau 250 to obtain additional data points that match and/or are associated with the initial data points received by the platform host 200 from the user 100. Once the platform host 200 registers the user device 100, the platform host 200 then creates a user profile associated with the user device 100 by populating the user profile with the one or more received user data points. The platform host 200 then begins processing a match routine by comparing the available user data points associated with the user profile with the available user data points associated with another user profile. The platform host 200 then scores the result of the match routing according to a pre-determined scoring rubric. In some embodiments, the scoring rubric gives equal weight to each relevant user data point or category thereof In other embodiments, the scoring rubric gives great weight to certain user data points deemed to be more relevant to the purpose of the comparison.

The comparing and scoring steps are then repeated by the platform host 200 over a pre-determined number of match routines. Then the platform host 200 ranks the results of the match routine based on the relative output of the scoring rubric. The platform host 200 displays on a user interference the ranking, which may be displayed in ascending, descending, or other ranking order depending on the pre-determined setting of the platform host 200 or, optionally, of a filter request received from the user device. The platform host 200 then receives an interaction request from the user device 100 corresponding to at least one other user device displayed on the rankings, which interaction request is processed by the platform host 200 to initiate a communication or transaction between the user device 100 and the at least one other user device provided on the displayed rankings.

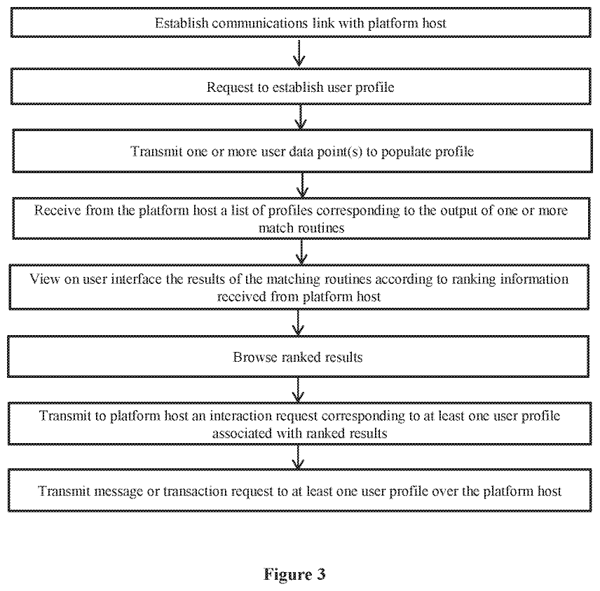

With reference to FIG. 3, shown are the method steps from the perspective of the user device 100 according to one embodiment. A communications link is established between a user device 100 and the platform host 200. The user device 100 transmits to the platform host 200 a request to establish a user profile. The user device 100 then populates the associated user profile by transmitting to the platform host 200 one or more user data points. Once the user profile is created, the user device 100 then automatically receives from the platform host 200 a list of other user profiles corresponding to the output of one or more matching routines. The user device 100 views on its user interface the results according to a ranking received from the platform host 200. The user device 100 then browses the results and transmits an interaction request to the platform host 200 corresponding to at least one other user device. The user device 100 can then transmit a message or transaction request to the at least one other user device via the platform host 200.

### Exemplary Data Points

The following is a non-exhaustive list of user data points that may be provided as input into a user profile and made operative for a matching routine: Location; Age; Generation; Gender; Language; Education level; Field of study; School; Ethnic affinity; Income and net worth; Homeownership and type; Home value; Property size; Square footage of home; Year home was built; Household composition; Users who have an anniversary within 30 days; Users who are away from family or hometown; Users who are friends with someone who has an anniversary, is newly married or engaged, recently moved, or has an upcoming birthday; Users in long-distance relationships; Users in new relationships; Users who have new jobs; Users who are newly engaged; Users who are newly married; Users who have recently moved; Users who have birthdays soon; Parents; Expectant parents; Mothers, divided by “type” (soccer, trendy, etc.); Users who are likely to engage in politics; Conservatives and liberals; Relationship status; Employer; Industry; Job title Office type; Interests; Users who own motorcycles; Users who plan to buy a car (and what kind/brand of car, and how soon); Users who bought auto parts or accessories recently; Users who are likely to need auto parts or services; Style and brand of car you drive; Year car was bought; Age of car; How much money user is likely to spend on next car; Where user is likely to buy next car; How many employees your company has; Users who own small businesses; Users who work in management or are executives; Users who have donated to charity (divided by type) Operating system; Users who play canvas games; Users who own a gaming console; Internet browser; Email service; Early/late adopters of technology; Expats (divided by what country they are from originally); Users who belong to a credit union, national bank or regional bank; Users who investor (divided by investment type); Number of credit lines; Users who are active credit card users; Credit card type; Users who have a debit card; Users who carry a balance on their credit card; Users who listen to the radio; Preference in TV shows; Users who use a mobile device (divided by what brand they use); Internet connection type; Users who recently acquired a smartphone or tablet; Users who access the Internet through a smartphone or tablet; Users who use coupons; Types of clothing user's household buys; Time of year user's household shops most; Users who are “heavy” buyers of beer, wine or spirits; Users who buy groceries (and what kinds); Users who buy beauty products; Users who buy allergy medications, cough/cold medications, pain relief products, and over-the-counter meds; Users who spend money on household products; Users who spend money on products for kids or pets, and what kinds of pets; Users whose household makes more purchases than is average; Users who tend to shop online (or off); Types of restaurants user eats at; Kinds of stores user shops at; Users who are; “receptive” to offers from companies offering online auto insurance, higher education or mortgages, and prepaid debit cards/satellite TV; Length of time user has lived in a house; Users who are likely to move soon; Users who are interested in the Olympics, fall football, cricket or Ramadan; Users who frequently travel, for work or pleasure; Users who commute to work; Types of vacations user tend to go on; Users who recently returned from a trip; Users who recently used a travel app; Users who participate in a timeshare; Users who have a change in employment; Users who are recently retired; Business Users that are owned independently; Business Users that have paid employees; Business Users that have shipments; Business users that are family owned; Business users with military veterans employees; Business users that have a private equity investment; Business users that have outsourced employment; Business users that have franchises; Business users with intellectual property Business users separated by year of inception; Business users by type of industry; Business Users by location; Business Users by income; Business Users that have had an initial public offering; Business Users with multiple offices; Business Users looking to sell; Business Users looking to build environmental habitats; Business Users desiring to contract with governments; Business Users desiring to contract with a business; Business Users desiring to contract with individuals; Business Users that invest in financial assets; Business Users that invest in real estate; Business Users with health professionals; Business Users with environmental professional; Business users that operate in the entertainment industry; Business users that operate in the medical industry; Business users that operate in the real estate industry; Business users that operate in the technology industry; Business users that operate in the legal industry; Municipalities that have a political orientation; Municipalities that have an economy in growth; Municipalities that have un-used land; Municipalities that have grants; Municipalities that have natural oil; Municipalities that have natural gas; Municipalities that have tourism; Municipalities that have manufacturing; Municipalities that have mining; Municipalities that have agriculture; Municipalities that have a hydro-electricity; Municipalities that have climate mitigation planning; Municipalities that have public transportation; Municipalities that have identified the demographics of their population; Municipalities that have identified the economics of their area; Municipalities that have identified the percentage of the population in employment; Municipalities that have identified the percentage of the population that vote; Municipalities that have different levels of schooling, from kindergarten to college; Municipalities that have automobile dependency; Municipalities that have working electricity and water; address of school that user and partner's children attend; address of close friend's home; location or job of user and partner.

Other data relevant as user data points include several categories of behavioral or predictive data. For example, user data points may comprise “Time Stamped” data points that are used to collect behavioral data such as clicking individual buttons on websites or doing searches. With this type of data, the matching routine can identify matches by comparing the data capture time (event time) or collected time (processing times) with an ideal outcome in a category before searching. For example, if a user profile indicates interest in an architect, the system could process this and show an architect that might match their preference based on the time-sensitive nature of the search.

In another example, user data points may comprise “spatial data” to be used to predict vehicle trajectories that make up geographical routes. Matching trajectory data could, in one embodiment, show the optimal way with the best stops based on a plurality of user data points. This could be used for day to day travel or vacation planning. It could also be used to locate the ideal home within a given area with a proximity to other important reference points, such as doctors, cinemas, and other points of interest.

In yet another example, user data points may comprise “Attribute Data.” Attribute data points are used to collect data to describe a building's characteristics that may or may not be visible such as the number of floors, height, or materials. Another type would describe the environmental surroundings such as the number of buildings, parks, lakes, roads, coasts, etc. With this type of data, the system could run match routines based on traits of locations. For example, if a user is looking to for ways to plan a city, or construct a building, a match routine could generate results zoning data and present a development solution for the user without needing to search and spend months planning. Alternatively, a user interested in a location for agricultural purposes to determine an ideal farming area would be shown a location match without the user searching based on traits such as levels of pollution, forestry, or sun exposure.

### Exemplary Scoring Rubrics

As discussed above, the platform host 200 is operable to apply a variety of scoring rubrics to the matching routines.

In some embodiments, a simple “1-to-1” scoring routine applies equal weight to each relevant user data point that is compared. In this example, if the platform host 200 determines that ten (10) particular user data points are relevant to a give matching routine, then the platform host will assign a score of “1” to a given user data point if it identically or substantially matches the user data point of another profile. If there is no match, the score is “0”. Thus, for a given comparison, if nine (9) out of the ten (10) relevant user data points are a match, then the relevancy score would be 90%. If in another similar comparison, eight (8) out of ten (10) relevant user data points are a match, then the relevancy score would be 80% and the latter comparison would be ranked below the former, meaning the latter is a “less relevant” match than the first.

In other embodiments, a weighted scoring routine applies unequal weight to the relevant user data points. In this example, the platform host 200 may determine that for a given transaction that there are five (5) relevant data points for a given match routine. Of those five, the platform host 200 considers location more important than age, age more important that income, income more important than size of family, size of family more important than job type, and job type more important than highest level of education. Location may be determined to be the overwhelmingly important factor and is thus given 50% of the weight, with the remaining 50% of the weight assigned to the other four factors in descending fashion, i.e. 20% to age, 15% to income, 10% job type, and 5% to highest level of education. Accordingly, the match routine will apply the associated weight to each relevant user data point when carrying out the comparison. In this example, it is possible that the highest ranked result would be that which matches only in location, even if the three of the other four factors are an identical match. In this way, the platform host 200 can curate results based on context.

It should be appreciated and understood that whether a user data point “matches” is not necessarily dependent on the given compared user data points being identical or substantially similar. In some embodiments, the compared user data points could be determined a “match” if they are complimentary to one another, for example a user interested in attending live sporting events may be a match for a car dealer selling pickup trucks or sport-utility vehicles, which may be useful for tailgating or hauling an entire family to such sporting events. Accordingly, the platform host 200 can be programmed according to a variety of tendencies amongst users, particularly in the commercial context. In some embodiments, these tendencies may be obtained by the platform host 200 from a plurality of data service bureaus 250 that aggregate such information including relevant consumer desires and tendencies.

### Market Applicability

The present invention has applicability across a wide variety of situations and markets. With respect to commercial transactions, the following is a non-exhaustive list of situations in which the present invention is useful, including an identification of relevant service bureau databases if desired or relevant to the application.

Industrial: Matching manufacturing companies with suppliers to facilitate the purchasing of parts to produce vehicles or furniture. By way of the system and method, manufacturers will source suppliers without the need to actively search. In the case, the service bureau may comprise an industrial supplier database that provides the platform host with a list of suppliers and their associated user data points, or the platform host itself may be populated with a plurality of user profiles identified as suppliers based on the user data points of such profiles.

Business to Business: An engineering equipment company looking to sell equipment or services to a construction company. By way of the system and method, the engineering company will find a construction company to buy its equipment or retain its services without the need to actively search. In the case, the service bureau may comprise an construction contractor database that provides the platform host with a list of contractors and their associated user data points, or the platform host itself may be populated with a plurality of user profiles identified as contractors based on the user data points of such profiles.

Professional Services: A recruitment company desires to source job applicants to refer to a business for employment. By way of the system and method, the recruitment company will find suitable employees with the need to actively search. In the case, the service bureau may comprise an employer database that provides the platform host with a list of willing employers and their associated user data points, or the platform host itself may be populated with a plurality of user profiles identified as employers based on the user data points of such profiles.

Financial Services: Private equity investors desire to invest capital into a project. By way of the system and method, the investors can identify suitable investment opportunities without the need to actively search. In the case, the service bureau may comprise an business brokerage database that provides the platform host with a list of businesses seeking investments and their associated user data points, or the platform host itself may be populated with a plurality of user profiles identified as wanting businesses based on the user data points of such profiles.

Business to government: A municipality needs an advertiser to promote a location or a service provider to provide telecommunications. By way of the system and method, the municipality can identify a suitable advertiser or telecom company without the need to actively search. In the case, the service bureau may comprise a municipal service provider database that provides the platform host with a list of qualified service providers and their associated user data points, or the platform host itself may be populated with a plurality of user profiles identified as qualified service providers based on the user data points of such profiles.

Business to consumer: An advertiser desires to sell a product or service to target a consumer directly. By way of the system and method, the advertiser can target a consumer directly without paying per impression or per click. In the case, the service bureau may comprise a consumer database that provides the platform host with a list of qualified consumers and their associated user data points, or the platform host itself may be populated with a plurality of user profiles identified as qualified consumers based on the user data points of such profiles.

Durable Goods: A retailer sells a product or service in store. By way of the system and method, the retailer can target a consumer by audio or visual cues while a customer is walking by an area without the retailer approaching the customer. In the case, the service bureau may comprise a consumer database that provides the platform host with consumer information and associated user data points, or the platform host itself may be populated with a plurality of user profiles identified as qualified consumers based on the user data points of such profiles.

Food and Beverage: A customer desiring to order food at the place of business or elsewhere. By way of the system, the restaurant can offer certain menu items according to that customer's preferences without customer searching such items. Alternatively, the restaurant can prepare the meal for in-dining or delivery without the consumer having to actively place a food order.

Transportation service market: Transportation company or companies offering mobility-as-a-service or ridesharing can prepare trips, journeys, or experiences. By way of the system and method, a transportation company can prepare a journey or itinerary for the passenger without the passenger making plans. In the case, the service bureau may comprise a consumer travel and waypoint database that provides the platform host with a list of relevant traveling passengers and their associated user data points, or the platform host itself may be populated with a plurality of user profiles identified as traveling passengers based on the user data points of such profiles.

Consumer to Consumer: An online marketplace where consumers can sell or buy without a middleman. By way of the system and method, a buyer can find a home to purchase from a seller without a real estate agent and without the need to actively search. In the case, the service bureau may comprise a multiple-listing service data that provides the platform host with a list of qualified “for sale by owner” consumers and their associated user data points, or the platform host itself may be populated with a plurality of user profiles identified as “for sale by owner” consumers based on the user data points of such profiles. The multiple-listing service may also provide to the platform host a list of properties available for sale and the relevant property data points associated with such for sale properties such as location, size, type, proximity to points of interest, and the like (among the other user data points described herein). The relevant property data points would populate a user profile associated with the property and/or the seller of the property. In this way, the system can execute a match routine comparing the relevant user data points of the buyer's user profile with the property data points of one or more sellers in order to generate real estate match results most relevant to the buyer's wants and needs, all without requiring the buyer to search the system.

Consumer to business: Influencers, reviewers or critics desire to source business to monetize their value. By way of the system and method, the influencers, reviewer or critic can find an advertiser, travel company or publisher without the need to actively search. In the case, the service bureau may comprise a business database that provides the platform host with a list of qualified business that are active online and their associated user data points, or the platform host itself may be populated with a plurality of user profiles identified as qualified businesses based on the user data points of such profiles.

### Social and Other Features of Platform

It is appreciated and understood that the present system and method may be embodied by one or more software applications or websites. Within such applications or website environments, the system may include various social features including the ability to chat, direct message, and post, view and otherwise interact with text, photographs, videos, or other content.

### Explanation of Computing Environment

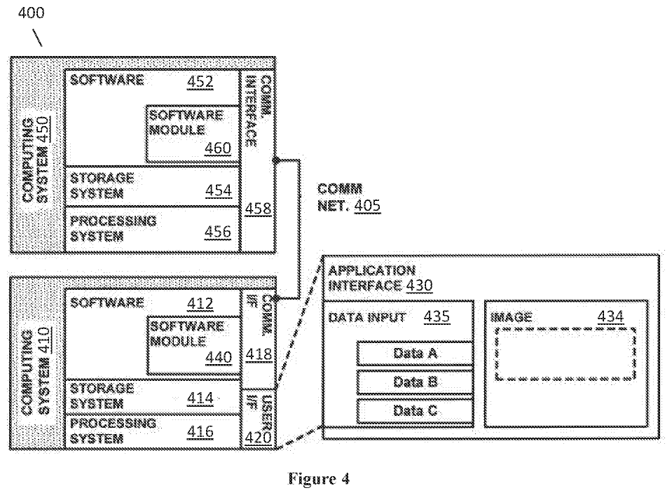

FIG. 4 illustrates a computing environment 400 according to one embodiment. Computing environment 400 includes computing system 410 and computing system 450. Computing system 410, in the present example, corresponds to user devices 100 that can send and receive data and information, and computing system 450 corresponds to system platform host 200 that can also send and receive data and information. Computing system 410 can include any smart phone, tablet computer, laptop computer, or other computing or mobile device capable of reading, and/or recording data about systems, devices, locations, and/or equipment, etc. Computing system 450 can include any server computer, desktop computer, laptop computer, or other device capable of storing and managing data communication by and between one or more computing systems 410 and the data service bureau 250 and other similar computing systems. Either system 410 or 450 can be capable of accomplishing any of the steps of functions described in this description.

In FIG. 4, computing system 410 includes processing system 416, storage system 414, software 412, communication interface 418, and user interface 420. Processing system 416 loads and executes software 412 from storage system 414, including software module 440. When executed by computing system 410, software module 440 directs processing system 416 to receive data, images, devices, locations, and/or equipment, etc. Such data could include any of the information described above, including but not limited to the functionality described herein.

Although computing system 410 includes one software module in the present example, one or more modules could provide the same operation. Similarly, the computing systems may be distributed using other computing systems and software.

Additionally, computing system 410 includes communication interface 418 that can be further configured to transmit data to and receive data from computing system 450 using communication network 405 (which represents the communications network 300 show in FIG. 1). Communication network 405 could include the Internet, cellular network, satellite network, RF communication, blue-tooth type communication, near field, or any other form of communication network capable of facilitating communication between computing systems 410 and 450.

Referring still to FIG. 4, processing system 416 can comprise a microprocessor and other circuitry that retrieves and executes software 412 from storage system 414. Processing system 416 can be implemented within a single processing device but can also be distributed across multiple processing devices or sub-systems that cooperate in executing program instructions. Examples of processing system 416 include general purpose central processing units, application specific processors, and logic devices, as well as any other type of processing device, combinations of processing devices, or variations thereof. Storage system 414 can comprise any storage media readable by processing system 416, and capable of storing software 412. Storage system 414 can include volatile and nonvolatile, removable and non-removable media implemented in any method or technology for storage of information, such as computer readable instructions, data structures, program modules, or other data. Storage system 414 can be implemented as a single storage device but may also be implemented across multiple storage devices or sub-systems. Storage system 414 can comprise additional elements, such as a controller, capable of communicating with processing system 416.

Application interface 430 can include data input 435 and image display 434. In one example, data input 435 can be used to collect information and data inputs from the user. It should be understood that although computing system 410 is shown as one system, the system can comprise one or more systems to collect data.

Computing system 450 includes processing system 456, storage system 454, software 452, and communication interface 458. Processing system 456 loads and executes software 452 from storage system 454, including software module 460. When executed by computing system 450, software module 460 directs processing system 410 to store and manage the data from computing system 410 and other similar computing systems. Although computing system 410 includes one software module in the present example, it should be understood that one or more modules could provide the same operation.

Additionally, computing system 450 includes communication interface 458 that can be configured to send and receive data to and from computing system 410 and/or data service bureau 250 using communication network 405.

Referring still to FIG. 4, processing system 456 can comprise a microprocessor and other circuitry that retrieves and executes software 452 from storage system 454. Processing system 456 can be implemented within a single processing device but can also be distributed across multiple processing devices or sub-systems that cooperate in executing program instructions. Examples of processing system 456 include general purpose central processing units, application specific processors, and logic devices, as well as any other type of processing device, combinations of processing devices, or variations thereof.

Storage system 454 can comprise any storage media readable by processing system 456, and capable of storing software 452 and data from computing system 410. Data from computing system 410 may be stored in a word, excel, or any other form of digital file. Storage system 454 can include volatile and nonvolatile, removable and non-removable media implemented in any method or technology for storage of information, such as computer readable instructions, data structures, program modules, or other data. Storage system 454 can be implemented as a single storage device but may also be implemented across multiple storage devices or sub-systems. Storage system 454 can comprise additional elements, such as a controller, capable of communicating with processing system 456.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

In some examples, computing systems 410 and 450 an include a user interface. The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The user input and output devices are well known in the art and need not be discussed at length here.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A method of automatically matching and ranking records to facilitate user interaction and transactions, comprising:
a. on a platform host, establishing a communications link with a user device;
b. receiving on the platform host from the user device a request to establish a user profile;
c. registering, on the platform host, the user device by receiving from the user device one or more user data points;
d. creating, on the platform host, a user profile associated with the user device, the user profile associated with the user data points;
e. without receiving a request from the user device, comparing the user data points of the user profile with user data points of another user profile;
f. scoring, on the platform host, the comparison step based on a pre-determined scoring rubric to determine a relevancy score associated with the comparison step;
g. without receiving a request from the user device, repeating steps (e) and (f) on a pre-determined number of additional user profiles;
h. ranking, on the platform host, results based on the relevancy score associated with each comparison step; and
i. displaying, on a user interface of the user device, the user profiles associated with the ranked results.

2. The method of claim 1, further comprising the step of receiving, on the platform host, an interaction request from the user device with respect to another user profile identified in the displayed user profiles.

3. The method of claim 2, further comprising the step of initiating a communication or interaction between the user device and the other user profile for which an interaction request was received.

4. The method of claim 1, wherein additional user data points corresponding to the user device are received from a data service bureau.

5. The method of claim 1, wherein the scoring rubric comprises a weighted score of the compared of data points wherein a first data point is given greater weight than a second data point, the second data point is given greater weight than a third data point, the third data point is given greater weight than a fourth data point.

6. The method of claim 1, wherein the scoring rubric comprises a non-weighted score of the compared of data points wherein a first data point is given the same weight as a second data point, the second data point is given the same weight as a third data point, the third data point is given the same weight as a fourth data point.

7. A method of automatically matching and ranking records to facilitate user interaction and transactions, comprising:
a. on a user device, establishing a communications link with a platform host;
b. requesting, on the user device, to establish a user profile with the platform host;
c. transmitting from the user device to the platform host one or more data points to populate a user profile on the platform host;
d. without transmitting a request, receiving from the platform host a list of other user profiles corresponding to output of one or more match routines;
e. viewing, on a user interface associated with the user device, a list of user profiles according to ranking information received from the platform host;
f. browsing on the user interface the ranked user profiles;
g. transmitting to the platform host an interaction request corresponding to at least one other user profile associated with the ranked user profiles; and
h. transmitting a message or transaction request to the at least one other user by way of the platform host;

8. The method of claim 7, further comprising the step of transmitting to the platform host an interaction request corresponding to at least one other user profile associated with the ranked user profiles.

9. The method of claim 8, further comprising the step of transmitting a message or transaction request to the at least one other user by way of the platform host.

10. The method of claim 7, wherein the user interface facilitates interaction with the platform host by way of swiping, sliding, voice commands, body gestures, or combinations thereof.

11. A system for automatically matching and ranking records to facilitate user interaction and transactions, comprising:
one or more user devices in communication with the at least one platform host over a communications network;
the platform host in communication with one or more data service bureaus by way of the communications network;
wherein the platform host is operable to carry out a method comprising:
a. receiving on the platform host from the user device a request to establish a user profile;
b. registering, on the platform host, the user device by receiving from the one or more user data points from the user device and the one or more service bureaus;
c. creating, on the platform host, a user profile associated with the user device, the user profile associated with the user data points;
d. without receiving a request from the user device, comparing the user data points of the user profile with user data points of another user profile;
e. scoring, on the platform host, the comparison step based on a pre-determined scoring rubric to determine a relevancy score associated with the comparison step;
f. without receiving a request from the user device, repeating steps (d) and (e) on a pre-determined number of additional user profiles;
g. ranking, on the platform host, results based on the relevancy score associated with each comparison step; and
h. displaying, on a user interface of the user device, the user profiles associated with the ranked results.
